(19) United States
(12) Patent Application Publication
(10) Pub. No.: US 2025/0060034 A1
(43) Pub. Date: Feb. 20, 2025

(54) METHOD OF GUIDING VEHICLE SHIFT TIMING

(71) Applicants: HYUNDAI MOTOR COMPANY, Seoul (KR); Kia Corporation, Seoul (KR)

(72) Inventors: Sung Hyun Cho, Yongin-si (KR); Soo Han Song, Seoul (KR); Seong Hwan Cheong, Suwon-si (KR); Joseph D Chang, Suwon-si (KR)

(73) Assignees: HYUNDAI MOTOR COMPANY, Seoul (KR); Kia Corporation, Seoul (KR)

(21) Appl. No.: 18/793,077

(22) Filed: Aug. 2, 2024

(30) Foreign Application Priority Data
Aug. 14, 2023 (KR) 10-2023-0106060
Jan. 16, 2024 (KR) 10-2024-0006832

(51) Int. Cl. F16H 63/42

(52) U.S. Cl. CPC F16H 63/42; F16H 2063/426

(57) ABSTRACT

A method of guiding vehicle shift timing which may provide information related to the shift timing to a driver includes determining, by a controller, a virtual engine speed of an electric vehicle, determining, by the controller, a predicted speed limit arrival time taken for the determined virtual engine speed to reach a predetermined speed limit, controlling, by the controller, operation of a shift indicator configured to guide manual shift timing based on the determined virtual engine speed and predicted speed limit arrival time, and operating, by the controller, the shift indicator to provide shift timing information to the driver.

### CROSS-REFERENCE TO RELATED APPLICATION

The present application claims priority to Korean Patent Provisional Application No. 10-2023-0106060 filed on Aug. 14, 2023, and Korean Patent Application No. 10-2024-0006832 filed on Jan. 16, 2024, the entire contents of which is incorporated herein for all purposes by this reference.

### BACKGROUND OF THE PRESENT DISCLOSURE

### Field of the Present Disclosure

The present disclosure relates to a method of guiding vehicle shift timing. More particularly, it relates to a method of guiding vehicle shift timing which may provide information related to the shift timing to a driver.

### Description of Related Art

In general, an internal combustion engine vehicle is equipped with an engine and a transmission, and an engine speed and a gear shift position (i.e., the position of a gear shift) are displayed on the instrument panel of the vehicle so that a driver may recognize the real-time driving status of the vehicle.

An electric vehicle does not have an engine but is equipped with a motor and a virtual shift system, and may control motor torque through the virtual shift system to provide a shift feeling equivalent to the shift feeling of the internal combustion engine vehicle to a driver.

Furthermore, the conventional virtual shift system outputs and displays a virtual engine speed and a virtual gear shift position on the instrument panel of the inside of the vehicle, and may thus provide the driver with a visual effect similar to riding in an internal combustion engine vehicle.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Accordingly, when an electric vehicle enters the manual shift mode through a virtual shift system, a driver may manually operate a shift control device based on a virtual engine speed and a target gear shifting position provided through an instrument panel.

Meanwhile, in an internal combustion engine vehicle, an engine speed is maintained close to a speed limit to maintain the driving force of the vehicle at a high value when shifting manually.

However, as the engine speed of the internal combustion engine vehicle approaches the speed limit, the driving force of the vehicle decreases, and when the engine speed reaches the speed limit, power cut occurs due to fuel cut.

In the case of the electric vehicle, because the shift control device is manually operated based on the virtual engine speed, there is no need to maintain the virtual engine speed at a value close to the speed limit to maintain the driving force of the vehicle at a high value when shifting manually.

However, to implement characteristics more identical to those of the internal combustion engine vehicle, it is possible to maintain the virtual engine speed close to the speed limit. In the instant case, as the virtual engine speed reaches the speed limit, power cut due to fuel cut is implemented. Power cut due to fuel cut in the internal combustion engine vehicle may be implemented by blocking power supplied to the drive motor of the electric vehicle.

Therefore, when attempting to increase the virtual engine speed close to the speed limit to maintain the maximum driving force of the electric vehicle in the manual shift mode, unintended cutoff of power of the drive motor may occur, and therefore, technology to prevent such a phenomenon is required.

Various aspects of the present disclosure are directed to providing a method of guiding vehicle shift timing that provides notification through a shift indicator so that a driver of an electric vehicle may recognize appropriate shift timing.

The objects of the present disclosure are not limited to the above-mentioned objects, and other objects not mentioned herein will be clearly understood by a person including ordinary skill in the art to which an exemplary embodiment of the present disclosure pertains from the following description.

Various aspects of the present disclosure are directed to providing a method of guiding vehicle shift timing, including determining, by a controller, a virtual engine speed of an electric vehicle, determining, by the controller, a predicted speed limit arrival time taken for the determined virtual engine speed to reach a predetermined speed limit, controlling, by the controller, operation of a shift indicator configured to guide manual shift timing based on the determined virtual engine speed and predicted speed limit arrival time, and operating, by the controller, the shift indicator to provide shift timing information to a driver.

In an exemplary embodiment of the present disclosure an exemplary embodiment of the present disclosure, the shift indicator may include light emitting elements provided on an instrument panel inside the electric vehicle and disposed in a predetermined shape, and the controller may be configured to determine targets to be turned on among the light emitting elements based on the virtual engine speed, may be configured to determine whether or not the targets to be turned on among the light emitting elements blink based on the predicted speed limit arrival time, and may output a control signal to control operation of the shift indicator based on the determined targets to be turned on and whether or not the targets to be turned on blink.

In another exemplary embodiment of the present disclosure, whenever the virtual engine speed increases and reaches a predetermined upward engine speed, the controller may increase a number of the targets to be turned on among the light emitting elements by one. Furthermore, whenever the virtual engine speed decreases and reaches a predetermined downward engine speed, the controller may decrease a number of the targets to be turned on among the light emitting elements by one.

In various exemplary embodiments of the present disclosure, the controller may be configured to determine the virtual engine speed based on a virtual gear ratio determined depending on a virtual gear position, an average wheel speed, and a tire dynamic radius of the electric vehicle. Furthermore, the controller may be configured to determine the predicted speed limit arrival time based on the virtual engine speed, a virtual speed limit, and a virtual engine angular acceleration.

In various exemplary embodiments of the present disclosure, when the predicted speed limit arrival time is less than or equal to a predicted arrival time predetermined for each virtual gear position, a virtual engine angular acceleration exceeds 0 (zero), and the electric vehicle is in a driving situation in which upshifting is not executed in a manual shift mode, the controller may be configured for controlling the shift indicator to be operated in a blinking mode.

In still various exemplary embodiments of the present disclosure, when the shift indicator is controlled to be operated in the blinking mode, the targets to be turned on among the light emitting elements of the shift indicator may be operated in the blinking mode.

In another exemplary embodiment of the present disclosure, the controller may be configured to determine whether or not the electric vehicle is in the driving situation in which the upshifting is not executed in the manual shift mode, based on a vehicle speed and an opening rate of an accelerator pedal.

In another further embodiment, when the predicted speed limit arrival time exceeds the predicted arrival time, or the virtual engine angular acceleration is less than or equal to 0 (zero), or the electric vehicle is in the driving situation in which upshifting is executed in the manual shift mode, the controller may not operate the shift indicator in the blinking mode.

In yet another further embodiment, the controller may be configured to determine the predicted speed limit arrival time even while the shift indicator is operated in the blinking mode, and may release the blinking mode of the shift indicator when the determined predicted speed limit arrival time is greater than or equal to a predetermined blinking mode release time, and the blinking mode release time may be determined as a value obtained by summing the predicted arrival time predetermined for each virtual gear position and a margin time.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

Other aspects and embodiments of the present disclosure are discussed infra.

The above and other features of the present disclosure are discussed infra.

### BRIEF DESCRIPTION OF THE DRAWINGS

FIG. 1 is a diagram showing main components of a system for guiding vehicle shift timing according to an exemplary embodiment of the present disclosure;

FIG. 2 is a diagram showing an instrument panel provided with a shift indicator according to an exemplary embodiment of the present disclosure; and

FIG. 3 is a flowchart showing a method of guiding vehicle shift timing according to various exemplary embodiments of the present disclosure.

It should be understood that the appended drawings are not necessarily to scale, presenting a somewhat simplified representation of various features illustrative of the basic principles of the present disclosure. The specific design features of the present disclosure as included herein, including, for example, predetermined dimensions, orientations, locations, and shapes, will be determined in portion by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter reference will be made in detail to various embodiments of the present disclosure, examples of which are illustrated in the accompanying drawings and described below. Matters included in the accompanying drawings are schematized to easily explain the exemplary embodiments of the present disclosure, and may differ from an actual implementation form.

An electric vehicle according to various exemplary embodiments of the present disclosure is provided with a virtual shift system that allows a driver to feel as when he or she is riding in an internal combustion engine vehicle, and is also provided with a gear shifting device which the driver may manually operate. The driver may manually change a shift gear position (or referred to as a “gear position”) by operating the gear shifting device. The gear shifting device may be provided at a position where the driver may easily operate the gear shifting device in the interior of the vehicle, and may be referred to as a shift control device in other words.

The virtual shift system is configured to determine a virtual gear position of the electric vehicle based on a vehicle speed and the opening rate (%) of an accelerator pedal in the automatic shift mode, and is configured to determine a current virtual gear position of the electric vehicle based on a virtual gear position of the electric vehicle when entering the manual shift mode and a driver's shift request signal input through the gear shifting device in the manual shift mode.

The virtual shift system may be selectively activated by the driver. For example, a touch button for activating the virtual shift system may be provided on the screen of a navigation system provided in the vehicle, and the virtual shift system may be activated when the driver touches the touch button.

Furthermore, the virtual shift system may selectively enter the manual shift mode by the driver. For example, when the driver operates the gear shifting device in the automatic shift mode of the virtual shift system, the virtual shift system may enter the manual shift mode.

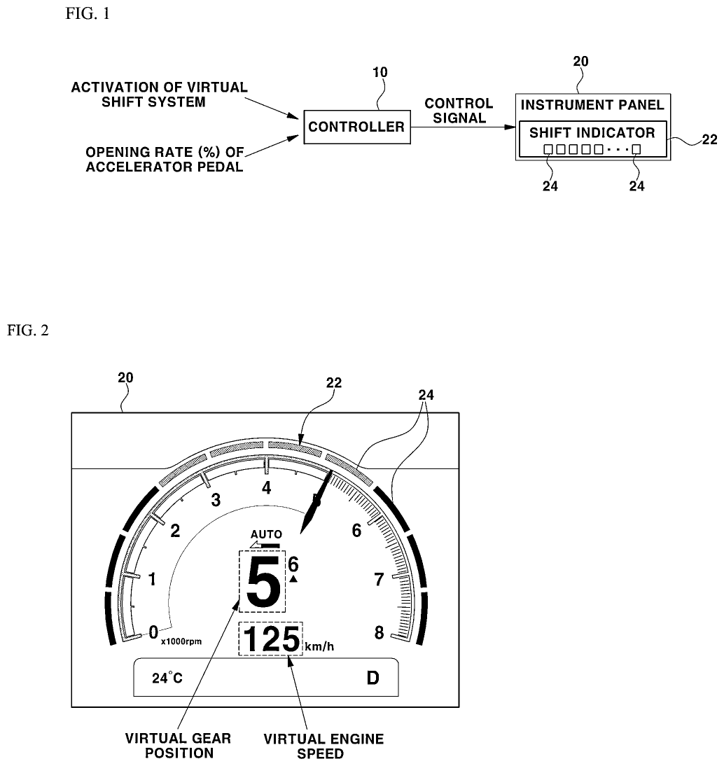

Referring to FIG. 1, a controller 10 according to various exemplary embodiments of the present disclosure is configured to perform overall control of the virtual shift system, and when the virtual shift system is activated, the controller 10 is configured to determine a current virtual gear position (i.e., a real-time virtual gear position) based on the vehicle speed and the opening rate value of the accelerator pedal. The controller 10 may be an in-vehicle controller configured to determine the state of the electric vehicle while driving and to perform overall control of the electric vehicle to maintain the optimum driving state of the electric vehicle.

Furthermore, when the virtual shift system is activated, the controller 10 is configured to calculate and to determine a virtual engine speed in real time depending on the current virtual gear position (i.e., an n^{th} gear position), and transmits a control signal to control operation of a shift indicator 22 based on the determined virtual engine speed.

The controller 10 is configured to determine the virtual engine speed based on an average wheel speed, a tire dynamic radius, and a virtual gear ratio of the electric vehicle, as shown in Equation 1 below. The average wheel speed is determined as an average value of the speed of a right driving wheel and the speed of a left driving wheel, and the virtual gear ratio is determined as a predetermined value depending on the current virtual gear position (i.e., the n^{th} gear position). In the automatic shift mode, the current virtual gear position (i.e., the n^{th} gear position) is determined based on a real-time vehicle speed and a real-time opening rate of the accelerator pedal. Furthermore, in the manual shift mode, the current virtual gear position (i.e., the n^{th} gear position) is determined based on a virtual gear position immediately before entering the manual shift mode or at a point in time when entering the manual shift mode and a driver's shift signal input through the gear shifting device. The tire dynamic radius is a radius of the tires while driving. The tire dynamic radius may be determined using a known determination method, and a detailed description thereof will thus be omitted. The controller (10) can obtain the data of the speed of the right driving wheel and the speed of the left driving wheel from the first wheel speed sensor and the second wheel speed sensor provided in the electric vehicle.

Virtual Engine Speed (n^{th} gear position)=Average Wheel Speed×{1000×(60×2×π)/Tire Dynamic Radius}×Virtual Gear Ratio Equation 1:

When the virtual shift system is activated, the controller 10 outputs and displays a current virtual engine speed value and a current virtual gear position value on an instrument panel 20 in the interior of the vehicle, as shown in FIG. 2.

Although not shown in the drawings, the instrument panel 20 displays various information related to the current driving state of the vehicle so that the driver may recognize the current driving state of the vehicle, and includes the shift indicator 22 configured to guide the driver on manual shift timing when the virtual shift system enters the manual shift mode. As shown in FIG. 2, the shift indicator 22 may include a plurality of light emitting elements 24 arranged approximately in a semicircle, and may be referred to as a “gear shifting timing indicator” in other words.

The shift indicator 22 is controlled by the controller 10. The shift indicator 22 may be operated so that the light emitting elements 24 arranged in a predetermined shape are sequentially turned on or off in a predetermined order. The light emitting elements 24 may be turned or off based on the virtual engine speed determined in real time.

When the virtual engine speed increases above a predetermined upward engine speed, the number of targets to be turned on among the light emitting elements 24 increases by one, and when the virtual engine speed decreases below a predetermined downward engine speed, the number of the targets to be turned on among the light emitting elements 24 decreases by one. The number of the targets to be turned on among the light emitting elements 24 may sequentially increase or decrease in the arrangement direction of the light emitting elements 24. Color light emitting diodes (LEDs) may be used as the light emitting elements 24 to further increase visibility and recognition.

The upward engine speed at which each light emitting element 24 is turned on and the downward engine speed at which each light emitting element 24 is turned off are predetermined depending on each virtual gear position, and may be stored in a memory of the controller 10. Whenever the virtual engine speed increases and reaches a predetermined upward engine speed, the light emitting elements 24 of the shift indicator 22 are sequentially turned on one by one, and thereby, the number of light emitting elements 24 which are turned on increases.

To operate the above-described shift indicator 22, the controller 10 may be configured to determine targets to be turned on among the light emitting elements 24 based on the current virtual engine speed and the current virtual gear position. Whenever the virtual engine speed increases and reaches the predetermined upward engine speed, the controller 10 may increase the number of the targets to be turned on among the light emitting elements 24 by one.

For example, when the virtual engine speed gradually increases and reaches a first upward engine speed, a first light emitting element 24 becomes a target to be turned on, and when the virtual engine speed further increases and reaches a second upward engine speed, a second light emitting element 24 also becomes a target to be turned on. The second upward engine speed is higher than the first upward engine speed, and the second light emitting element 24 is a light emitting element 24 closest to the first light emitting element 24 in the arrangement direction of the light emitting elements 24.

Furthermore, whenever the virtual engine speed gradually decreases and reaches a predetermined downward engine speed, the controller 10 may decrease the number of the targets to be turned on among the light emitting elements 24 by one. In other words, whenever the virtual engine speed gradually decreases and reaches the predetermined downward engine speed, the controller 10 may increase the number of targets to be turned off among the light emitting elements 24 by one.

For example, when the virtual engine speed gradually decreases and reaches a first downward engine speed, a third light emitting element 24 is excluded from the targets to be turned on and is thus turned off, and when the virtual engine speed further decreases and reaches a second downward engine speed, a fourth light emitting element 24 is excluded from the targets to be turned on and is thus turned off. The second downward engine speed is lower than the first downward engine speed, and the fourth light emitting element 24 is a light emitting element 24 closest to the third light emitting element 24 in the arrangement direction of the light emitting elements 24.

The present disclosure may visually inform the driver of a degree to which the virtual engine speed is close to a virtual speed limit by sequentially including or excluding the light emitting elements 24 of the shift indicator 22 in and from the targets to be turned on in a predetermined order.

Furthermore, to control the above-described shift indicator 22, the controller 10 is configured to determine and monitor the virtual engine speed in real time, and compares the virtual engine speed determined in real time with the predetermined upward engine speed or downward engine speed for each virtual gear position.

Meanwhile, when the virtual engine speed of the electric vehicle increases and reaches the predetermined virtual speed limit, the controller 10 implements fuel cut occurring when the engine speed of an internal combustion engine vehicle reaches a speed limit, and power cut due to such fuel cut. To implement power cut due to fuel cut of the internal combustion engine vehicle, the controller 10 may forcibly cut off driving force (i.e., power) of a vehicle driving motor that generates the driving force of the electric vehicle.

Accordingly, to prevent a situation in which the power of the vehicle driving motor is cut off, the controller 10 predicts the situation before the virtual engine speed reaches the virtual speed limit, and informs the driver of the situation in which the power of the vehicle driving motor is cut off to prevent cut-off of power of the motor.

The controller 10 may provide the driver with information related to shift timing in the manual shift mode by controlling the shift indicator 22 to be operated in a blinking mode, and at the same time, may warn the driver in advance of the power cutoff situation of the vehicle driving motor.

The controller 10 is configured to calculate and to determine a change rate of the virtual engine speed over time (i.e., a virtual engine angular acceleration), and is configured to determine a predicted speed limit arrival time T_arrival based on the virtual engine angular acceleration. The predicted speed limit arrival time T_arrival may be determined as Equation 2 below.

T_arrival (sec)=(Virtual Speed Limit−Virtual Engine Speed)/Virtual Engine Angular Acceleration Equation 2:

The predicted speed limit arrival time T_arrival is an estimated time taken for the virtual engine speed to reach the virtual speed limit in real time. Here, the virtual speed limit is a preset value, but is not necessarily fixed to one value and may vary depending on the driving mode of the vehicle, etc. For example, the virtual speed limit when driving in the normal mode and the virtual speed limit when driving in the sports mode may be different. A map for determining the virtual speed limit based on the driving mode, etc. may be constructed in advance, and may be stored in the memory of the controller 10.

In the manual shift mode of the virtual shift system, the controller 10 is configured to determine whether or not the shift indicator 22 blinks based on the predicted speed limit arrival time T_arrival, the virtual engine angular acceleration, and whether or not the electric vehicle is in a driving situation in which upshifting is not executed.

Upon determining that the predicted speed limit arrival time T_arrival is less than or equal to a predicted arrival time A predetermined for each virtual gear position, the virtual engine angular acceleration exceeds 0 (zero), and the electric vehicle is in the driving situation in which the upshifting is not executed in the manual shift mode of the virtual shift system, the controller 10 is configured to control the shift indicator 22 to be operated in the blinking mode. When the shift indicator 22 is controlled to be operated in the blinking mode, a light emitting device 24 or light emitting devices 24 determined as the target(s) to be turned on among the light emitting devices 24 of the shift indicator 22 are operated in the blinking mode.

That is to say, the controller 10 operates the shift indicator 22 in the blinking mode, when the predicted speed limit arrival time T_arrival is less than or equal to the predicted arrival time A and the virtual engine speed is increasing in the driving situation in which upshifting is not executed, thereby being capable of informing the driver that the electric vehicle has reached appropriate timing to perform upshifting.

Furthermore, when driver's shift operation is not executed and the virtual engine speed further increases while the shift indicator 22 is operated in the blinking mode, the number of the targets to be turned on among the light emitting elements 24 may increase. In the instant case, as the virtual engine speed increases, a greater number of light emitting elements 24 may be operated in the blinking mode, thereby being capable of visually notifying the driver that the virtual engine speed is gradually approaching the virtual speed limit.

In an exemplary embodiment of the present disclosure, the predicted arrival time A is set differently for each virtual gear position thereof. This is because the lower the gear position in an internal combustion engine vehicle, the larger the gear ratio and the faster the engine speed changes depending on the vehicle speed.

To implement the shift characteristics of the internal combustion engine vehicle, the virtual shift system of the electric vehicle increases the change rate of the virtual engine speed depending on the vehicle speed as the current virtual gear position decreases, and thus, the predicted arrival time A for each virtual gear position is determined differently.

The predicted arrival time A may become relatively shorter as the current virtual gear position increases. This is because, in the case of a general internal combustion engine vehicle, the gear ratio increases as the drive (D) position decreases from high to low, and the gear ratio decreases as the drive (D) position increases from low to high. Based on the same engine power, the engine speed is changed depending on the gear ratio of each drive (D) position, and as the gear ratio increases, the displacement of the engine speed depending on the vehicle speed increases. Therefore, the lower the drive (D) position, the longer the predicted arrival time A.

Furthermore, when the virtual gear position is the neutral (N) position or the park (P) position, the predicted arrival time A may be set to a larger time value than the predicted arrival time A set for each drive (D) position except for the 1^{st} gear position. This is because the engine is in an unloaded state when the gear shifting is located at the neutral (N) position or the park (P) position in the internal combustion engine vehicle, and thus, the engine speed increases rapidly in proportion to the opening rate of the accelerator pedal compared to the case in which the gear shifting is located at the drive (D) position. In the internal combustion engine vehicle, when the gear shifting is located at the neutral (N) position or the park (P) position, power transmission between the engine and wheels is cut off and engine power is used only to increase the engine speed, and thus, the engine speed rises relatively rapidly. Therefore, because the displacement of the engine speed is large, the predicted arrival time A should be set to a large value to predict a change in the engine speed.

As an exemplary embodiment of the present disclosure, the predicted arrival time A for each virtual gear position may be set forth in Table 1 below.

TABLE 1

| | Gear position | | | | | | | | |
|---|---|---|---|---|---|---|---|---|---|
| | P/N | 1 | 2 | 3 | 4 | 5 | 6 | 7 | 8 |
| Time | 600 | 780 | 580 | 430 | 250 | 210 | 160 | 160 | 160 |
| (ms) | | | | | | | | | |

Furthermore, whether or not the vehicle is in the driving state in which upshifting is not executed may be determined based on the real-time vehicle speed and the opening rate of the accelerator pedal. For example, when the real-time vehicle speed is greater than or equal to a predetermined vehicle speed and the opening rate of the accelerator pedal is greater than or equal to a predetermined opening rate, it may be determined that the electric vehicle is in a driving state in which upshifting is executable. Furthermore, when the real-time vehicle speed is less than the predetermined vehicle speed and the opening rate of the accelerator pedal is less than the predetermined opening rate, it may be determined that the electric vehicle is in the driving state in which upshifting is not executed.

Meanwhile, even while the shift indicator 22 is operated in the blinking mode, the predicted speed limit arrival time T_arrival may vary depending on the virtual engine speed, etc. That is, when the virtual engine speed gradually decreases while the shift indicator 22 is operated in the blinking mode, the predicted speed limit arrival time T_arrival may increase. For example, when operation of the accelerator pedal is released and thus the vehicle coasts while the shift indicator 22 is operated in the blinking mode, the virtual engine speed is reduced.

Therefore, the controller 100 is configured to calculate and to determine the predicted speed limit arrival time T_arrival even while the shift indicator 22 is operated in the blinking mode, and compares the determined predicted speed limit arrival time T_arrival with a blinking mode release time A+B obtained by summing the predicted arrival time A and a margin time B. The controller 10 releases the blinking mode of the shift indicator 22 when the predicted speed limit arrival time T_arrival is greater than or equal to the blinking mode release time A+B. The controller 10 maintains the blinking mode of the shift indicator 22 when the predicted speed limit arrival time T_arrival is less than the blinking mode release time A+B. The margin time B is set to a margin time for the predicted arrival time A for each virtual gear position.

The present disclosure may provide notification of manual shift timing to the driver by operating the shift indicator 22 in the blinking mode while the virtual shift system of the electric vehicle enters the manual shift mode, and helps the driver shift gears at an appropriate timing. Accordingly, the driver may drive more sportily and drive to maximize power performance, and the present disclosure may be usefully used during extreme driving, such as track driving.

Furthermore, the present disclosure allows the driver to visually recognize that the virtual engine speed is gradually approaching the virtual speed limit through control of the shift indicator 22, and may thus induce the driver to shift gears before the virtual engine speed reaches the virtual speed limit, thereby being capable of preventing motor power cutoff caused by the virtual engine speed reaching the virtual speed limit.

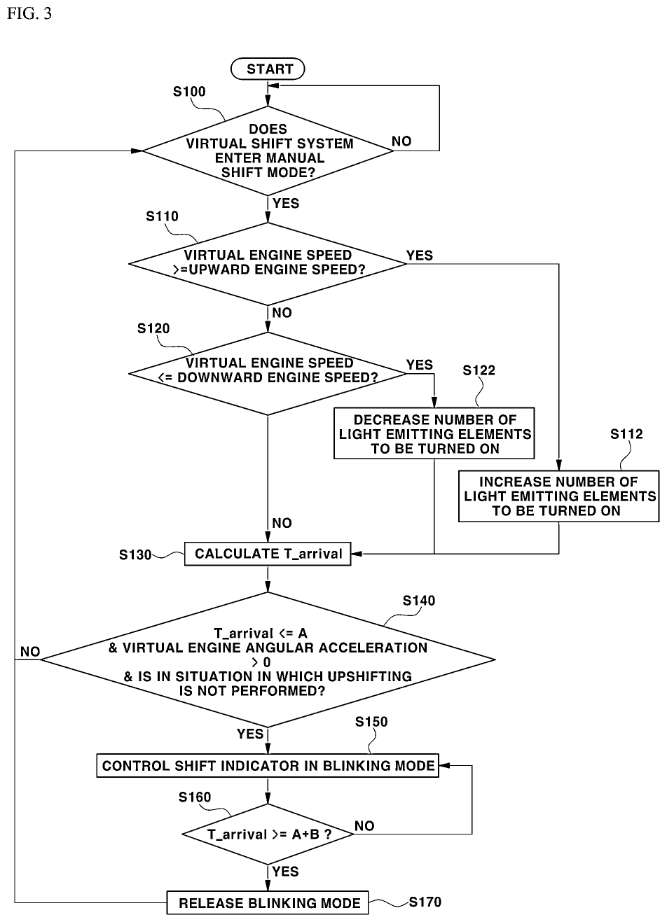

FIG. 3 is a flowchart showing a method of guiding vehicle shift timing according to various exemplary embodiments of the present disclosure. The method will be described in more detail with reference to FIG. 3.

As shown in FIG. 3, when the virtual shift system is activated, the controller 10 is configured to determine whether or not the virtual shift system enters the manual shift mode (S100).

When the virtual shift system enters the manual shift mode and a virtual engine speed is increasing, the controller 10 compares the virtual engine speed with an upward engine speed determined for each virtual gear position (S110). When the virtual engine speed is greater than or equal to the upward engine speed, the number of targets to be turned on among the light emitting elements 24 of the shift indicator 22 increases by one (S112). When the virtual engine speed is less than the upward engine speed, the number of the targets to be turned on among the light emitting elements 24 of the shift indicator 22 does not increase.

Furthermore, when the virtual engine speed is decreasing, the controller 10 compares the virtual engine speed with a downward engine speed determined for each virtual gear position (S120). When the virtual engine speed is less than or equal to the downward engine speed, the number of the targets to be turned on among the light emitting elements 24 of a shift indicator 22 decreases by one (S122). When the virtual engine speed exceeds the downward engine speed, the number of the targets to be turned on among the light emitting elements 24 of the shift indicator 22 does not decrease.

When the virtual engine speed increases and reaches the determined upward engine speed, a corresponding light emitting element 24 in a predetermined order among the light emitting elements 24 of the shift indicator 22 may be turned on. That is, whenever the virtual engine speed reaches the upward engine speed set to a higher value than the virtual engine speed, the number of the targets to be turned on among the light emitting elements 24 of the shift indicator 22 increases by one.

That is, when the virtual engine speed gradually increases and reaches the predetermined upward engine speed set to the higher value than the virtual engine speed, a light emitting element 24 corresponding to the first turn among the light emitting elements 24 of the shift indicator 22 may be turned on.

Furthermore, when the virtual engine speed gradually decreases and reaches the determined downward engine speed, a corresponding light emitting element 24 in a predetermined order among the light emitting elements 24 of the shift indicator 22 may be turned off. That is, whenever the virtual engine speed reaches the downward engine speed set to a lower value than the virtual engine speed, the number of the targets to be turned on among the light emitting elements 24 of the shift indicator 22 decreases by one.

When the number of the targets to be turned on gradually increases and all the light emitting elements 24 are operated in the blinking mode, the shift indicator 22 may warn the driver that the virtual engine speed will reach the virtual speed limit within a short time period.

Thereafter, in Operation S130, the controller 10 is configured to calculate and to determine a predicted speed limit arrival time T_arrival based on the virtual engine speed, etc.

Thereafter, the controller 10 is configured to determine whether or not the determined the predicted speed limit arrival time T_arrival, a virtual engine angular acceleration, and a driving situation satisfy predetermined conditions, respectively (S140). When the predicted speed limit arrival time T_arrival is less than or equal to a predicted arrival time A predetermined for each virtual gear position, the virtual engine angular acceleration exceeds 0 (zero), and the electric vehicle is in a driving situation in which upshifting is not executed in the manual shift mode, the controller 10 is configured to control the shift indicator 22 to be operated in the blinking mode (S150).

On the other hand, when any of the determined predicted speed limit arrival time T_arrival, the virtual engine angular acceleration, and the driving situation does not satisfy the predetermined conditions, the controller 10 does not control the shift indicator 22 in the blinking mode, and may re-execute Operation S100.

That is, when the predicted speed limit arrival time T_arrival exceeds the predicted arrival time A, or the virtual engine angular acceleration is less than or equal to 0 (zero), or the electric vehicle is in the driving situation in which upshifting is executed in the manual shift mode, the controller 10 does not operate the shift indicator 22 in the blinking mode. Here, a light emitting element 24 or light emitting elements 24 included in the targets to be turned on may be turned on, but are not operated in the blinking mode.

The controller 10 monitors the predicted speed limit arrival time T_arrival in real time even while the shift indicator 22 is operated in the blinking mode. The predicted speed limit arrival time T_arrival determined in real time is compared with a blinking mode release time A+B obtained by summing the predicted arrival time A and a margin time B (S160). The controller 10 maintains the blinking mode of the shift indicator 22 when the predicted speed limit arrival time T_arrival is less than the blinking mode release time A+B, and releases the blinking mode of the shift indicator 22 when the predicted speed limit arrival time T_arrival is greater than or equal to the blinking mode release time A+B (S170). The predicted arrival time A and the margin time B are predetermined time values for each virtual gear position.

Even while the shift indicator 22 is operated in the blinking mode, the virtual engine speed may be reduced, and accordingly, when the predicted speed limit arrival time T_arrival is extended, manual shift timing may be postponed. Therefore, the controller 10 may prevent unnecessary blinking of the shift indicator 22 by monitoring the predicted speed limit arrival time T_arrival even while the shift indicator 22 is operated in the blinking mode.

Meanwhile, the above-described shift indicator control method of the present disclosure may also be applied to internal combustion engine vehicles. However, when the present control method is applied to internal combustion engine vehicles, actual values are used instead of virtual values. For example, an actual engine speed may be applied instead of the virtual engine speed, and an actual speed limit may be applied instead of the virtual speed limit.

As is apparent from the above description, the present disclosure provides the following effects.

First, information related to a virtual engine speed and a virtual gear position is displayed on an instrument panel in the interior of an electric vehicle, and information related to manual shift timing is displayed through a shift indicator of the instrument panel, being capable of guiding a driver on appropriate shift timing in the manual shift mode, and thus allowing a driver to drive more sportily and providing driving fun to the driver.

Second, as the virtual engine speed approaches a virtual speed limit, the number of targets to be turned on among light emitting elements of the shift indicator increases, allowing the driver to visually recognize a degree to which the virtual engine speed is adjacent to the virtual speed limit. Accordingly, notification informing that the virtual engine speed is approaching the virtual speed limit may be provided to the provider before the virtual engine speed reaches the virtual speed limit, and power cut of a vehicle driving motor due to the virtual engine speed reaching the virtual speed limit may be prevented by inducing the driver to shift gears.

The effects of the present disclosure are not limited to the above-mentioned effects, and other effects not mentioned herein will be clearly understood by those skilled in the art from the above description.

Furthermore, the term related to a control device such as “controller”, “control apparatus”, “control unit”, “control device”, “control module”, “control circuit”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may be configured for processing data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

Hereinafter, the fact that pieces of hardware are coupled operably may include the fact that a direct and/or indirect connection between the pieces of hardware is established by wired and/or wirelessly.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A method of guiding vehicle shift timing, the method comprising:
determining, by a controller, a virtual engine speed of an electric vehicle;
determining, by the controller, a predicted speed limit arrival time taken for the determined virtual engine speed to reach a predetermined virtual speed limit;
controlling, by the controller operatively connected to a shift indicator, operation of the shift indicator configured to guide manual shift timing, based on the determined virtual engine speed and predicted speed limit arrival time; and
operating, by the controller, the shift indicator to provide shift timing information to a driver.

2. The method of claim 1,
wherein the shift indicator includes light emitting elements provided on an instrument panel inside the electric vehicle and arranged in a predetermined shape, and
wherein, in providing the shift timing information to the driver, the controller is configured to:
determine targets to be turned on among the light emitting elements based on the virtual engine speed;
determine whether or not the targets to be turned on among the light emitting elements blink based on the predicted speed limit arrival time; and
output a control signal to control operation of the shift indicator, based on the determined targets to be turned on and whether or not the targets to be turned on blink.

3. The method of claim 2, wherein, whenever the virtual engine speed increases and reaches a predetermined upward engine speed, the controller is further configured to increase a number of the targets to be turned on among the light emitting elements by one.

4. The method of claim 2, wherein, whenever the virtual engine speed decreases and reaches a predetermined downward engine speed, the controller is further configured to decrease a number of the targets to be turned on among the light emitting elements by one.

5. The method of claim 1, wherein the controller is further configured to determine the virtual engine speed based on a virtual gear ratio determined depending on a virtual gear position, an average wheel speed, and a tire dynamic radius of the electric vehicle.

6. The method of claim 1, wherein the controller is further configured to determine the predicted speed limit arrival time based on the virtual engine speed, a virtual speed limit, and the virtual engine angular acceleration.

7. The method of claim 2, wherein, in response that the predicted speed limit arrival time is less than or equal to a predicted arrival time predetermined for each virtual gear position, a virtual engine angular acceleration exceeds 0 (zero), and the electric vehicle is in a driving situation in which upshifting is not executed in a manual shift mode, the controller is further configured to control the shift indicator to be operated in a blinking mode.

8. The method of claim 7, wherein, in response that the shift indicator is controlled to be operated in the blinking mode, the targets to be turned on among the light emitting elements of the shift indicator are operated in the blinking mode.

9. The method of claim 7, wherein the controller is further configured to determine whether or not the electric vehicle is in the driving situation in which the upshifting is not executed in the manual shift mode, based on a vehicle speed and an opening rate of an accelerator pedal.

10. The method of claim 7, wherein, in response that the predicted speed limit arrival time exceeds the predicted arrival time, or the virtual engine angular acceleration is less than or equal to 0 (zero), or the electric vehicle is in the driving situation in which upshifting is executed in the manual shift mode, the controller is further configured to not operate the shift indicator in the blinking mode.

11. The method of claim 7,
wherein the controller is further configured to determine the predicted speed limit arrival time even while the shift indicator is operated in the blinking mode, and to release the blinking mode of the shift indicator in response that the determined predicted speed limit arrival time is greater than or equal to a predetermined blinking mode release time, and
wherein the blinking mode release time is determined as a value obtained by summing the predicted arrival time predetermined for each virtual gear position and a predetermined margin time.

12. An apparatus of guiding vehicle shift timing, the apparatus comprising:
a shift indicator;
a processor operatively connected to the shift indicator; and
a non-transitory storage medium containing program instructions,
wherein the processor is configured to, by executing the program instructions:
determine a virtual engine speed of an electric vehicle;
determine a predicted speed limit arrival time taken for the determined virtual engine speed to reach a predetermined virtual speed limit;
control operation of the shift indicator configured to guide manual shift timing, based on the determined virtual engine speed and predicted speed limit arrival time; and
operate the shift indicator to provide shift timing information to a driver.

13. The apparatus of claim 12,
wherein the shift indicator includes light emitting elements provided on an instrument panel inside the electric vehicle and arranged in a predetermined shape, and
wherein, in providing the shift timing information to the driver, the processor is configured to:
determine targets to be turned on among the light emitting elements based on the virtual engine speed;
determine whether or not the targets to be turned on among the light emitting elements blink based on the predicted speed limit arrival time; and
output a control signal to control operation of the shift indicator, based on the determined targets to be turned on and whether or not the targets to be turned on blink.

14. The apparatus of claim 13,
wherein, whenever the virtual engine speed increases and reaches a predetermined upward engine speed, the processor is further configured to increase a number of the targets to be turned on among the light emitting elements by one; and
wherein, whenever the virtual engine speed decreases and reaches a predetermined downward engine speed, the processor is further configured to decrease a number of the targets to be turned on among the light emitting elements by one.

15. The apparatus of claim 12, wherein the processor is further configured to determine the virtual engine speed based on a virtual gear ratio determined depending on a virtual gear position, an average wheel speed, and a tire dynamic radius of the electric vehicle.

16. The apparatus of claim 12, wherein the processor is further configured to determine the predicted speed limit arrival time based on the virtual engine speed, the virtual speed limit, and a virtual engine angular acceleration.

17. The apparatus of claim 13, wherein, in response that the predicted speed limit arrival time is less than or equal to a predicted arrival time predetermined for each virtual gear position, a virtual engine angular acceleration exceeds 0 (zero), and the electric vehicle is in a driving situation in which upshifting is not executed in a manual shift mode, the processor is further configured to control the shift indicator to be operated in a blinking mode.

18. The apparatus of claim 17, wherein, in response that the shift indicator is controlled to be operated in the blinking mode, the targets to be turned on among the light emitting elements of the shift indicator are operated in the blinking mode.

19. The apparatus of claim 17, wherein the processor is further configured to determine whether or not the electric vehicle is in the driving situation in which the upshifting is not executed in the manual shift mode, based on a vehicle speed and an opening rate of an accelerator pedal.

20. The apparatus of claim 17,
wherein the processor is further configured to determine the predicted speed limit arrival time even while the shift indicator is operated in the blinking mode, and to release the blinking mode of the shift indicator in response that the determined predicted speed limit arrival time is greater than or equal to a predetermined blinking mode release time, and
wherein the blinking mode release time is determined as a value obtained by summing the predicted arrival time predetermined for each virtual gear position and a predetermined margin time.
